(19) United States
(12) Patent Application Publication
(10) Pub. No.: US 2025/0126384 A1
(43) Pub. Date: Apr. 17, 2025

(54) Two-Part Speaker System

(71) Applicant: Apple Inc., Cupertino, CA (US)

(72) Inventors: Neal D. Evans, Cupertino, CA (US); Javier Mendez, San Jose, CA (US); James W. Vandyke

(21) Appl. No.: 18/729,284

(22) PCT Filed: Jan. 30, 2023
(86) PCT No.: PCT/US2023/061549

§ 371 Date: Jul. 16, 2024

Related U.S. Application Data
(60) Provisional application No. 63/267,370, filed on Jan. 31, 2022.

(51) Int. Cl. H04R 1/02; H04R 1/28; H04R 7/16

(52) U.S. Cl. CPC H04R 1/028; H04R 1/2857; H04R 7/16

(57) ABSTRACT

An electronic device can include a housing defining an opening, a speaker pod disposed within the housing, the speaker pod defining a port configured to align with the opening. The speaker pod can include a first speaker in fluid communication with a first channel, and a second speaker in fluid communication with a second channel. The first channel and the second channel converge to the port.

### CROSS-REFERENCE TO RELATED APPLICATION(S)

This claims priority to the PCT Application No. PCT/US2023/061549 filed 30 Jan. 2023 and entitled to “TWO-PART SPEAKER SYSTEM,” which claims priority to U.S. Provisional Patent Application No. 63/267,370, filed 31 Jan. 2022, and entitled “TWO-PART SPEAKER SYSTEM,” the entire disclosures of which are hereby incorporated by reference.

### FIELD

The described embodiments relate generally to electronic devices. More particularly, the present embodiments relate to speaker assemblies for electronic devices.

### BACKGROUND

Over the past several decades, electronic devices have drastically advanced in their functionality. Computer parts have been miniaturized, while also increasing in the amount of performance they can deliver. Electronic devices typically include a housing that surrounds internal system components, such as audio speaker assemblies, circuitry, processing units, display elements, and other electronic components. The reduced dimensions of these various components can offer more efficient use of space, greater flexibility in the placement of components within a housing, reduced housing size and use of material, smaller device sizes, greater ease of transportation and use, and other options for device design.

Design of integrated speaker assemblies that maintain a broad frequency range and desirable acoustic performance levels can be challenging given the increasingly high demands for reduced size and high performance in a limited space.

### SUMMARY

According to an aspect of the present disclosure, an electronic device can include a housing defining an opening, a first speaker in fluid communication with a first channel, and a second speaker in fluid communication with a second channel, wherein the first channel and the second channel converge into a shared channel in fluid communication with the opening.

In some examples, the first speaker includes a woofer and the second speaker comprises a tweeter. The electronic device can further include a first mesh positioned at the opening, and a second mesh positioned at an interface between the woofer and the tweeter. The second mesh can have a higher density than the first mesh. The electronic device can include a barrier that covers the opening. The barrier can include a woven mesh, and a metallic screen defining an exterior of the electronic device.

In some examples, the first speaker includes a first diaphragm that oscillates along a first axis, and the second speaker can include a second diaphragm that oscillates along a second axis parallel to the first axis. The electronic device can include a wall to shield the second speaker from acoustic waves generated by the first speaker, the wall at least partially defining the second channel. The electronic device can include a speaker pod disposed within the housing. The speaker pod can define a port aligned with the opening, the first channel, and the second channel.

According to an aspect of the present disclosure, a speaker unit can include a housing defining an interior volume and an outlet, the outlet in fluid communication with the interior volume and an outside environment. The speaker unit can include a woofer positioned in the interior volume, the woofer can transmit first acoustic waves having frequencies between 20 Hz and 2 kHz through a woofer channel in fluid communication with the outlet, and a tweeter positioned in the interior volume and at least partially overlapping the woofer, the tweeter can transmit second acoustic waves having frequencies between 200 Hz and 20 kHz through a tweeter channel in fluid communication with the outlet.

In some examples, the woofer channel includes a tortuous path. The tortuous path can extend through a non-vertical interface of the woofer and the tweeter. In some examples, the overlap between the tweeter and the woofer defines the non-vertical interface. The woofer channel can define an outlet positioned at the non-vertical interface. The woofer can generate the first acoustic waves in a first direction. The woofer channel can guide the first acoustic waves in a second direction perpendicular to the first direction.

In some examples, the speaker unit can include a woofer mesh positioned between the woofer channel and the tweeter channel. The speaker unit can further include a tweeter mesh positioned at the outlet, wherein the woofer mesh comprises a woven fabric having a density higher than the tweeter mesh. The woofer channel can be at least partially defined by an interior surface of the housing.

According to some aspects, a speaker assembly can include a housing defining an interior volume and a port, the port can be in fluid communication with the interior volume and an outside environment, a woofer positioned in the interior volume, a tweeter positioned in the interior volume, an outlet defined by the woofer, the outlet can be disposed at an interface between the woofer and the tweeter, a first mesh covering the outlet, and a second mesh covering the port, the first mesh can be more dense than the second mesh.

In some examples, a first distance between the port and the tweeter can be smaller than a second distance between the port and the woofer. The speaker assembly can be housed in a personal electronic device. The port can be directed toward an ear of a user during operation. The speaker assembly can include a deformable foam positioned between the tweeter and the housing. The speaker assembly can include a deformable foam positioned between a channel wall and the housing.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a side view of an electronic device;

FIG. 1B shows a perspective view of an electronic device;

FIG. 1C shows a perspective view of an electronic device;

FIG. 1D shows a perspective view of an electronic device;

FIG. 2 shows a cross-sectional side view of a speaker assembly;

FIG. 3A shows a perspective view of a speaker assembly;

FIG. 3B shows a cross-sectional side view of a speaker assembly;

FIG. 3C shows a cross-sectional perspective view of a speaker assembly;

FIG. 3D shows a top perspective view of a speaker assembly;

FIG. 3E shows a bottom perspective view of a speaker assembly; and

FIG. 4 shows a perspective exploded view of a port barrier.

### DETAILED DESCRIPTION

Detailed representative embodiments are described below with reference to the examples illustrated in the accompanying drawings. The following descriptions are not intended to limit the embodiments to one preferred embodiment, but are intended to cover alternatives, modifications, and equivalents as can be included within the spirit and scope of the described embodiments as defined by the appended claims.

The following disclosure relates to speaker assemblies for electronic devices. More specifically, the following disclosure describes a two-part speaker assembly having a single outlet port. Electronic devices typically include a housing that surrounds internal system components, such as audio speaker assemblies, circuitry, processing units, display elements, and other electronic components. However, as electronic devices become smaller and smaller the available space for such components is reduced. Further, it may be desirable to reduce the number of openings or ports visible on the electronic device. The speaker assembly described herein uniquely addresses the challenges that arise from reductions in available space, as well as aesthetic and performance requirements.

In a particular embodiment, an electronic device, such as a head-mounted device (“HMD”), can include a housing defining an internal volume. The housing can also define an opening that is in fluid communication with the internal volume of the housing and with the ambient environment. A speaker assembly or unit can be positioned within the internal volume of the electronic device. In some examples, the speaker assembly is positioned within a support of an HMD, such as within a support arm or support band positioned along a user's head. The speaker assembly can be positioned proximate a user's ear and can be oriented to direct sound in the direction of the user's ear.

In some examples, the speaker assembly can include a speaker pod or housing that is positioned within the electronic device. The speaker pod can house various components of the speaker assembly. The speaker pod can further define a port or outlet that is aligned with the opening of the electronic device. Thus, the port can be in fluid communication with an interior volume of the speaker pod and with the outside environment. The speaker assembly can include multiple audio transducers or speakers.

The speaker can include a diaphragm coupled to a magnetic component. The magnetic component can include gaps or grooves within which is disposed a wound coil, such as a copper coil or any conductive coil that is capable of being influenced by an electromagnetic field. In some examples, the coil is capable of generating or being influenced by a desired electromagnetic field. The diaphragm can be affixed to the coil. As pulses of electricity pass through the coil, the direction of its magnetic field is rapidly changed, resulting in alternating attraction and repulsion to the magnetic component, causing vibrations back and forth. The coil can be attached to the diaphragm which amplifies these vibrations, pumping sound waves into the surrounding air. Notably, despite having multiple audio transducers, the speaker assembly may include only one outlet or port.

In one example, the speaker assembly includes a first speaker, such as a woofer, that is positioned within the pod and is in fluid communication with a first channel. The woofer channel can include a winding, tortuous path to the outlet port. A second speaker, such as a tweeter, can also be positioned within the pod and can be in fluid communication with a second channel or tweeter channel. As described in greater detail below, the woofer channel and the tweeter channel can merge, converge, or combine into a shared channel that leads to the port.

In some examples, the tweeter can at least partially overlap the woofer, thereby reducing the footprint of the assembly along at least one major dimension. This can enable the speaker pod to better fit within an electronic device with space constraints. In some examples, the speaker assembly can include a port barrier positioned at the port. The port barrier can cover the port. The port barrier can include a woven mesh, a metallic screen defining an exterior of the electronic device, and a support frame to reinforce the woven mesh. Likewise, the speaker assembly can include a woofer mesh positioned in a channel leading to the woofer. The woofer mesh can have a higher density than the mesh of the port barrier. In some examples, the woofer mesh can have a lower density than the port barrier mesh. Thus, the speaker assembly can include multiple meshes.

A challenge that arises from a shared port system as described herein is potential interference of the tweeter from the acoustic waves or sound generated by the woofer. The woofer diaphragm is larger than the tweeter diaphragm, and can therefore negatively impact operation of the tweeter. Accordingly, in some examples, the speaker assembly can include a wall positioned between the tweeter and the woofer channel. The wall can shield the tweeter from the acoustic waves generated by the woofer. In some examples, the shielding wall can at least partially defining the one or more of the channels of the speaker assembly and can be shaped to direct the flow of the sound.

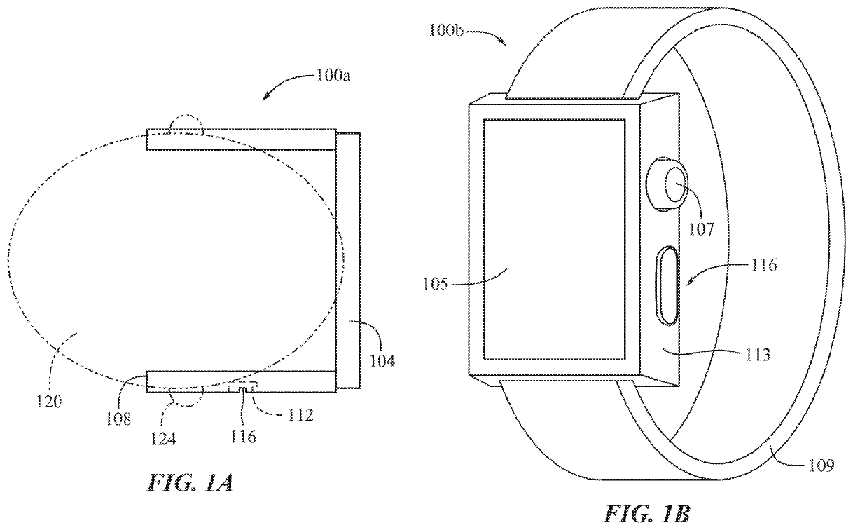

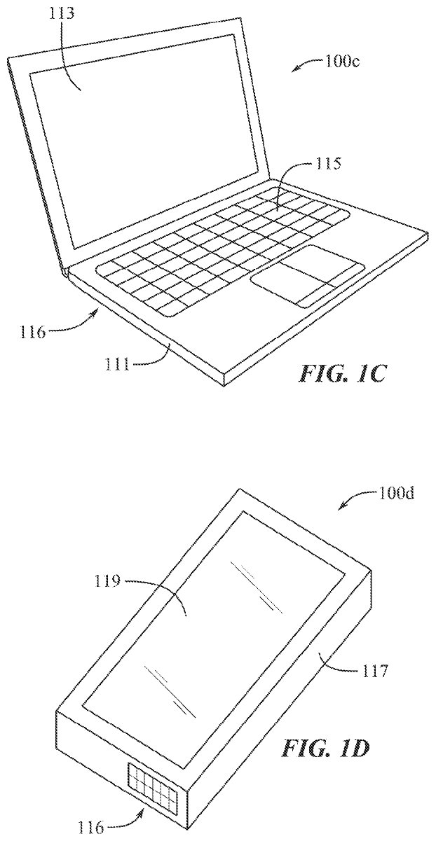

These and other embodiments are discussed below with reference to FIGS. 1-4. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

It will further be understood that various directional indicators used herein (e.g., up, down, sideways, vertical, horizontal, top, bottom, above, below, etc.) are made in relation to the orientation of the figure at issue. For example, a vertical axis is to be understood as an axis extending from a top of the page to a bottom of the page.

FIGS. 1A-1D illustrate various electronic devices that are capable of being used in conjunction with the speaker assembly described herein. The electronic devices can correspond to any form of a wearable electronic device, a portable media player, a media storage device, a portable digital assistant (“PDA”), a tablet computer, a computer, a mobile communication device, a GPS unit, a remote-control device, or any other electronic device. Specific examples of such devices are described below.

FIG. 1A illustrates an electronic device, such as a head-mounted device 100a positioned on a user's head 120. The head-mounted device can include a display device used for virtual or augmented reality simulations. The head-mounted device 100a can further relate to any form of computer glasses or smart glasses. The head-mounted device 100a can include a display 104 and a support 108, such as a headband or support arms. In some examples, the display 104 includes an opaque, translucent, transparent, or semi-transparent screen, including any number lenses, for presenting visual data.

The head-mounted device 100a can be worn on the user's head 120 such that the display 104 is positioned over the user's face and disposed over one or both of the user's eyes. The display 104 can be connected to the support 108. In some examples, the support 108 can be positioned against the side of a user's head 120 and in contact therewith. In some examples, the support 108 can be at least partially positioned above the user's ear or ears 124. In some examples, the support 108 can be positioned adjacent to the user's ear or ears 124. The support 108 can extend around the user's head 120. In this way, the display 104 and the support 108 can retain the head-mounted device 100a on the user's head 120. It should be understood, however, that this configuration is just one example of how the components of a modular head-mounted device 100a can be arranged, and that in some examples, a different number of connector straps and/or retention bands can be included.

The head-mounted device 100a can include a frame or housing that houses various electrical components. Various components of the display 104 can be housed within the housing. For example, the hardware and electronics which allow functionality of the HMD can be housed within the housing. The housing can be defined by any portion of the support 108 and/or the display 104.

In some examples, the head-mounted device 100a can include a speaker assembly 112. The speaker assembly 112 can be positioned in a housing of the head-mounted device 100a. For example, the speaker assembly 112 can be positioned in or on the support 108. The support 108 can define an opening 116 that is positioned proximate the speaker assembly 112 to permit passage of acoustic waves generated by the speaker assembly 112 to emit into the outside environment. In some examples, when the head-mounted device 100a is worn on the user's head 120, the speaker assembly 112 and the opening 116 are positioned proximate the user's ear 124. The support 108 and/or the opening 116 can be oriented such that sound can be directed toward the user's car 124 when the user 120 is wearing the head-mounted device 100a. Further details regarding electronic devices capable of implementing a single port speaker system are described below with reference to FIG. 1B.

FIG. 1B illustrates an example in which the electronic device is a wearable device 100b. The wearable device 100b can be a watch, such as a smartwatch. The wearable device 100b of FIG. 1B is merely one representative example of a device that can be used in conjunction with the components and methods disclosed herein. In other words, the wearable device 100b is one non-limiting example of a device that can include a single port speaker assembly as described herein.

The wearable device 100b can include an enclosure or housing 103. The housing 103 can be connected to a front display 105 and can have a strap 109 designed to attach the wearable device 100b to a user, or to provide wearable functionality. The housing 103 can define a port 116 that is in fluid communication with a speaker assembly disposed within the housing 103. A number of input elements, such as a rotatable crown and/or a button 107 can be attached to and can protrude from the housing 103. The housing 103 can define a single speaker port 116 that can be integrally formed in and defined by the housing 103.

In some examples, the wearable device 100b can include a speaker assembly (not shown in FIG. 1B). The speaker assembly can be positioned in the housing 103 of the wearable device 100b. The housing 103 can define the port 116 that is positioned in relation to the speaker assembly 112 to permit passage of acoustic waves generated by the speaker assembly to emit into the outside environment. In some examples, when the wearable device 100b is worn by a user, the port 116 is positioned or oriented to be directed toward the user's ear 124. The port 116 can be positioned such that sound can be directed toward the user's ear when the user is wearing the wearable device 100b. Further details regarding electronic devices capable of implementing a single port speaker system are described below with reference to FIG. 1C.

FIG. 1C illustrates an example in which the electronic device is a computer 100c, such as a laptop or desktop. The computer 100c of FIG. 1C is merely one representative example of a device that can be used in conjunction with the components and methods disclosed herein. Specifically, the computer 100c is one representative example of a device that can include a single port speaker assembly as described herein.

The computer 100c can include an enclosure or housing 111. The housing 111 can be connected to a display 113. The housing 111 can define a port 116 that is in fluid communication with a speaker assembly housed within the housing 111. A number of input members 115, such as a keyboard, can be attached to and can protrude from the housing 111.

The housing 111 can substantially define an internal volume and at least a portion of an exterior surface of the computer 100c. The display 113 can include a touch sensitive surface, such as a touchscreen. The display 113 can define an exterior surface of the computer 100c.

The housing 111 can also include features, such as such as button apertures or charging port apertures. In some examples, the housing 111 defines only a single speaker port 116 by the process described herein. The speaker port 116 can be integrally formed in and defined by the housing 111.

In some examples, the computer 100c can include a speaker assembly (not shown in FIG. 1C). The speaker assembly can be positioned in the internal volume of housing 111 of the computer 100c. The housing 111 can define the port 116 that is positioned in relation to the speaker assembly to permit passage of acoustic waves generated by the speaker assembly to emit into the outside environment. The port 116 can be positioned such that sound can be directed toward the user's ear when the user is using the computer 100c. Further details regarding electronic devices capable of implementing a single port speaker system are described below with reference to FIG. 1D.

FIG. 1D illustrates an example in which the electronic device is a mobile device 100d, such as a smartphone or tablet computer. The mobile device 100d of FIG. 1D is merely one representative example of a device that can be used in conjunction with the components and methods disclosed herein. Specifically, the mobile device 100d is merely one representative example of a device that can include a single port speaker assembly as described herein.

The mobile device 100d can include an enclosure or housing 117. The

housing 117 can be connected to a display 119. The housing 117 can define a port 116 that is in fluid communication with a speaker assembly disposed within the housing 117.

The housing 117 can substantially define at least a portion of an exterior surface of the mobile device 100d. The display 119 can include a touch sensitive surface, such as a touchscreen. The display 119 can define an exterior surface of the mobile device 100d.

The housing 117 can also include features, such as such as button apertures or charging port apertures. In some examples, the housing 117 defines only a single speaker port 116 by the process described herein. The speaker port 116 can be integrally formed in the housing 117.

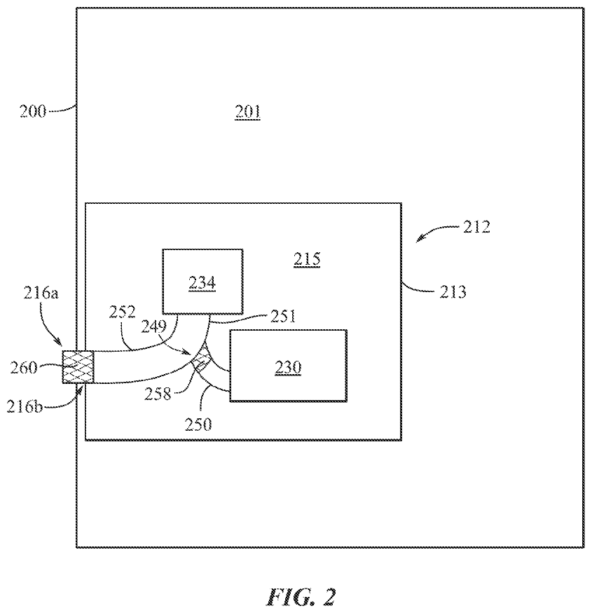

In some examples, the mobile device 100d can include a speaker assembly (not shown in FIG. 1C). The speaker assembly can be positioned in the housing 117 of the mobile device 100d. The housing 117 can define the port 116 that is positioned in relation to the speaker assembly 112 to permit passage of acoustic waves generated by the speaker assembly to emit into the outside environment. The port 116 can be positioned such that sound can be directed toward the user's ear when the user is using the mobile device 100d. Further details regarding speaker assemblies are described below with reference to FIG. 2.

FIG. 2 shows a schematic view of an electronic device 200 that includes a speaker assembly 212. The electronic device 200 can be substantially similar to, and can include some or all of the features of the electronic devices described herein, such as the head-mounted device 100a, the wearable device 100b, the computer 100c, and the mobile device 100d.

The electronic device 200 can define an interior volume 201 to house electronic components. The speaker assembly 212 can be positioned within the internal volume 201. In some examples, an entirety of the speaker assembly 212 is positioned within the internal volume 201. The electronic device 200 can define an aperture or opening 216a that is in fluid communication with the ambient environment and the speaker assembly 212.

The speaker assembly 212 can include a pod 213, which can otherwise be referred to as a speaker assembly housing or enclosure, which defines an internal volume 215 of the speaker assembly. The pod 213 can house various electrical and acoustic components. The speaker assembly 212 can include various acoustic components, such as audio transducers, woofers, tweeters, midrange drivers and any other types of drivers or speaker components.

In some examples, the speaker pod 213 includes a woofer 230 and a tweeter 234. The woofer 230 (also known as a bass speaker or a loudspeaker driver) can be designed to produce low frequency sounds. The woofer 230 can be an electrodynamic driver. In some examples, the woofer 230 can produce sound from about 50 Hz to about 2000 Hz.

The speaker assembly 212 can include a tweeter 234. The tweeter 234 can also be referred to as a treble speaker or loudspeaker. The tweeter 234 can be a speaker driver that produces acoustic output at a high frequency range or a range of frequencies higher than the range of frequencies output by the woofer. In some examples, the tweeter 234 produces sound from about 2 kHz to about 20 kHz. In some examples, the tweeter 234 can produce sound up to about 100 kHz. The tweeter 234 can be positioned to be proximate an opening, outlet, or port 216b in the speaker pod 213 that leads to the ambient environment. The port 216b can be aligned with or in fluid communication with the opening 216a defined by the housing of the electronic device 200.

Notably, in some examples, the speaker assembly 212 includes only one port 216b that vents sounds into the ambient environment. The tweeter 234 and the woofer 230 can be stacked vertically. For example, the tweeter 234 can be positioned over or on top (in relation to the view of FIG. 2) of the woofer 230. In some examples, the tweeter 234 overlaps the woofer 230 along a horizontal axis such that the woofer 230 and tweeter are stacked along a vertical axis. The stacking of the woofer 230 and the tweeter 234 can allow the speaker pod 213 to have a reduced dimension (e.g., along the horizontal axis). As shown, the tweeter 234 can be positioned closer to the port 216b than the woofer 230. In other words, a distance between the port 216b and the woofer 230 is greater than a distance between the port 216b and the tweeter 234.

The speaker assembly 212 can include internal walls or barrier components that define one or more channels, passages, or tunnels that are designed to guide sound within the speaker assembly 212. In some examples, a woofer channel 250 can be in fluid communication with an interior of the woofer 230 to receive sound produced by the woofer 230 and guide the sound, at least partially, to the port 216b. Likewise, a tweeter channel 251 can be in fluid communication with the tweeter 234 to receive sound produced by the tweeter 234 and guide the sound to the port 216b.

As described herein, the pod 213 can define a single outlet port 216b. Thus, in some configurations the woofer channel 250 and the tweeter channel 251 converge into a shared channel 252 leading to the port 216b. In at least one example, the woofer channel 250, tweeter channel 251, and the shared channel 252 can be formed as a single channel leading to a single port 216b. In other words, the woofer channel 250 can direct primarily low frequency sound generated by the woofer 230 and the tweeter channel 251 can direct primarily high frequency sound generated by the tweeter 234. Accordingly, the shared channel 252 can include both high and low frequency acoustic waves produced by both the woofer 230 and the tweeter 234. In some examples, the woofer channel 250 and the tweeter channel 251 terminate at the port 216b.

In at least one example, the shared channel 252 can be removed or reduced in size with the woofer channel 250 and the tweeter channel 252 extending to the port 216b.

In such an example, the woofer channel 250 can terminate at the tweeter channel 251 and the tweeter channel can terminate at the port 216. In this way, in at least one example, the woofer channel 250 and the tweeter channel 251 can join to form a single channel that terminates at a single port 216b. As shown in FIG. 2, the port 216b and opening 216 can align to form a single opening or port defined at least in part by an external housing 200 of the device 200 and visible from the outside environment.

In some examples, a mesh 258 can be positioned within or across the woofer channel 250. The mesh 258 can include cloth or fabric (also referred to as grille cloth, acoustic cloth, or speaker mesh) that is designed to allow for sound transmission through the material. The mesh 258 can aid in acoustic dampening, distortion control, and flow noise control.

The speaker mesh 258 can include a predetermined sound transmissibility suitable for sound generated by the woofer 230. The woofer 230 can have a frequency range of about 20 Hz to about 2 kHz. The tweeter 234 can have a frequency range of about 200 Hz to about 20 kHz. In some examples, the woofer 230 can have a frequency range as low as about 20 Hz to about 50 Hz, and as high as about 200 Hz to about 2 kHz. The tweeter 234 can have a frequency range as low as about 200 Hz to about 2 kHz, and as high as about 20 kHz. In some examples, the mesh 258 can allow for passage of frequencies lower than frequencies produced by the tweeter 234. For example, the mesh 258 can substantially allow sound generated by the woofer 230 below 2000 Hz to pass there through but substantially prevent or reduce the transmission of frequencies produced by the tweeter 234 from transferring therethrough. For example, the mesh 258 can substantially block or prevent sound frequencies above about 2000 Hz from transferring from the tweeter channel 252 backward into the woofer channel 250. The mesh 258 can at least partially block or prevent sound from the tweeter 234 from traveling into the woofer channel 250. The mesh 258 can be made from synthetic materials or threads in a woven pattern, or can include a foam. The mesh 258 can be an air-permeable component.

The mesh 258 can be positioned at or near a terminus or outlet 249 of the woofer channel 250. The mesh 258 can occupy substantially an entire volume defined by the woofer channel 250. In some other examples, however, the mesh 258 may only occupy a portion of the woofer channel 250. In use, the mesh 258 can serve to reduce the velocity of air flowing through the woofer channel 250, thereby reducing undesirable flow noise and providing for a clearer acoustic signal to be heard by the user. In some examples, the mesh 258 can block or prevent particle ingress through the woofer channel 250.

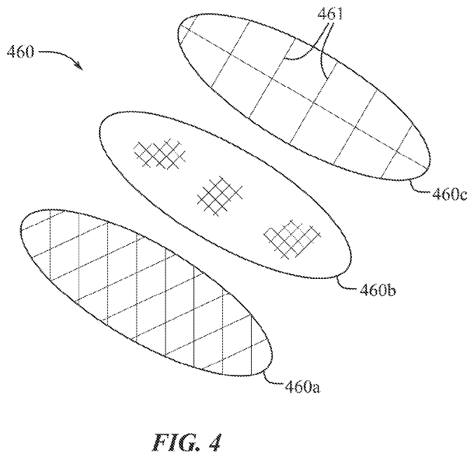

The speaker assembly 212 can include a port mesh 260 that is positioned within or across the opening 216a, the port 216b, and/or the shared channel 252. In some examples, the port mesh 260 is positioned across the tweeter channel 251. The port mesh can be substantially similar to the mesh 258. However, in at least one example, the port mesh 260 can have a lower density than the mesh 258. The port mesh 260 can include cloth or fabric that is designed to allow for easy sound transmission through the material. The port mesh 260 can include a predetermined sound transmissibility suitable for sound generated by the tweeter 234. The port mesh 260 can supplement the mesh 258 in further dampening the sound. In some examples, the port mesh 260 can allow for passage of frequencies as high as 20 kHz. The port mesh 260 can be made from synthetic materials or threads in a woven pattern. As described in greater detail with regard to FIG. 4, a cosmetic steel screen can be combined with the port mesh 260 to define an exterior of the electronic device 200. Further, a frame defined by a series of support ribs can support the port mesh 260 to prevent damage to the port mesh 260.

The port mesh 260 can be an air-permeable component. In some examples, the port mesh 260 can occupy substantially an entire volume defined by at least one of the shared channel 252, the port 216b, and the opening 216a. In some other examples, however, the port mesh 260 may only occupy a portion of at least one of the shared channel 252, the port 216b, and the opening 216a. In use, the port mesh 260 can serve to reduce the velocity of air flowing through the shared channel 252, thereby reducing undesirable flow noise and providing for a clearer acoustic signal to be heard by a user.

In some examples, the port mesh 260 can block or prevent particle ingress through the shared channel 252.

As noted above and shown in FIG. 2, the mesh 258 can be disposed between the woofer channel 250 and the tweeter channel 252 such that the mesh 258 aid in acoustic dampening, distortion control, and flow noise control for specific frequencies output by the woofer 230 without attenuating or otherwise interfering with the passage of sound frequencies passing through the tweeter channel 252 and out the port mesh 260. In this way, the denser mesh 258 provides the advantages tuned for the sound output by the woofer 230 and the port mesh is configured to optimally provide dampening, distortion control, and flow noise control of the higher frequencies output by the tweeter 234 without those same high frequencies having to first passing through the mesh 258. As noted above, the port mesh 260 is also configured to allow the passage of lower frequencies from the woofer 230 to pass through the port 216b and the opening 216a without substantially or noticeably attenuating or otherwise interfering with the woofer sound. In this way, with both the mesh 258 and port mesh 260 positioned as shown in

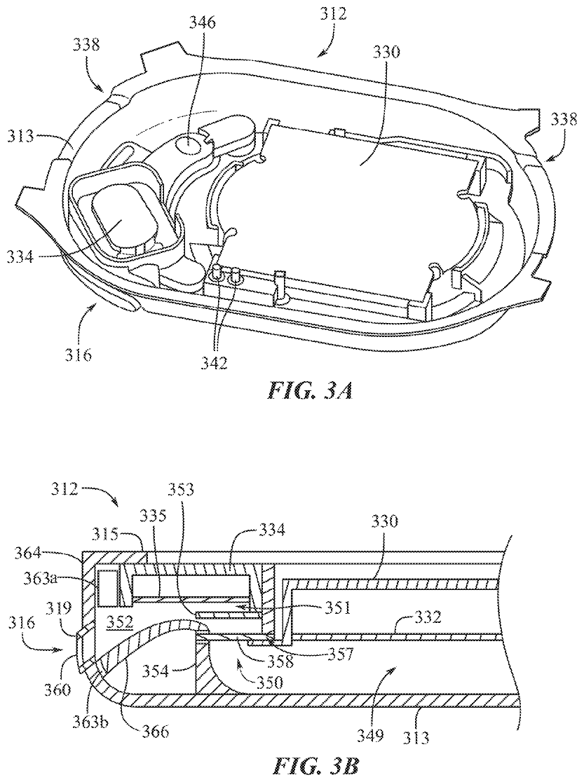

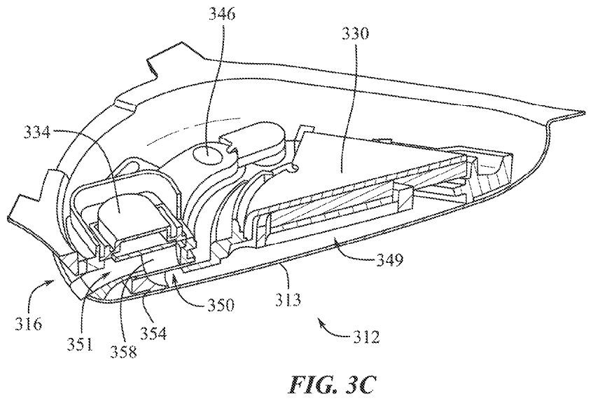

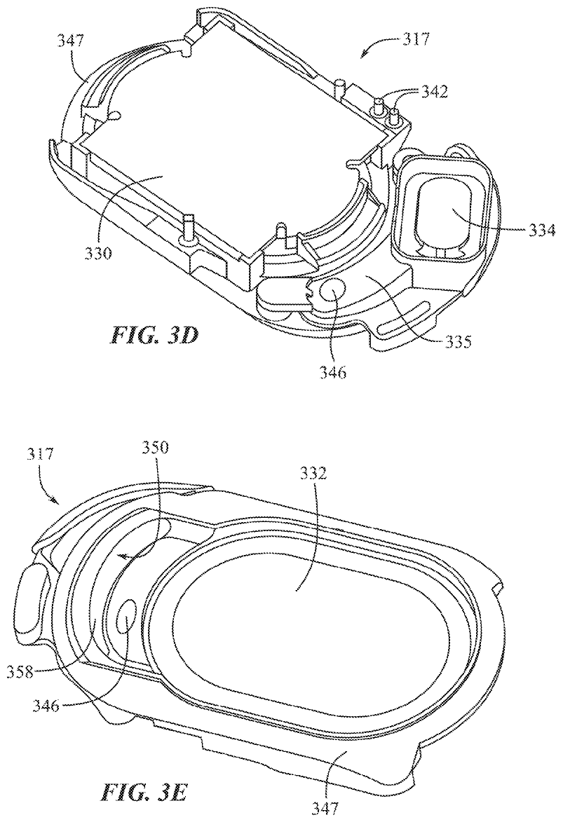

FIG. 2, both the lower woofer frequencies and the higher tweeter frequencies produced by the speaker assembly 212 can be optimally controlled for quality as the sound passes through a single shared outlet or aperture, such as the opening 216a. Further details regarding speaker assemblies are described below with reference to FIG. 3A-3E.

FIG. 3A illustrates a top perspective view of an example of a speaker assembly 312. The speaker assembly 312 can be substantially similar to, and can include some or all of the features of the speaker assemblies described herein, such a speaker assembly 112 and 212. FIG. 3A is merely one illustrative example of how the speaker assembly 312 can be designed and is not limited to the depicted design or componentry. As illustrated, the speaker assembly 312 can include a housing or pod 313 that houses various components of the speaker assembly 312, such as audio transducers. The pod 313 can include stainless steel. In some examples, the pod 313 can include a bottom portion (shown in FIG. 3A) and a top portion (not shown). The top and bottom portions of the pod 313 can substantially surround or encapsulate the components of the speaker assembly 312. The bottom portion of the pod 313 can include a curved or non-planar surface that defines an internal volume, such as internal volume 215 of FIG. 2. The speaker assembly 312 can include an elastomeric gasket (not shown in FIG. 3A) positioned around a perimeter of the pod 313. The elastomeric gasket can provide a seal between the top portion and bottom portion of the pod 313. In some examples, the pod 313 does not include a top portion, but is instead sealed directly to an interior surface of the housing of the electronic device.

As illustrated in FIG. 3A, the pod 313 can house a woofer 330 and a tweeter 334. The tweeter 334 can be positioned at least partially adjacent to the woofer 330. As described herein, the tweeter 334 can at least partially stack or overlap the woofer 330 in order to accommodate for a reduced dimension of the pod 313.

The pod 313 can define the port 316, out of which sound from both the woofer 330 and tweeter 334 are emitted into the ambient environment. As discussed herein, the pod 313 can include or define a single outlet port 316. The single outlet port 316 can improve an aesthetic appearance of the electronic device. Further, the single outlet port 316 can provide the advantage of having fewer entry points for dust, particles, or debris, thereby reducing the likelihood of foreign objects entering the electronic device. The pod 313 can define grooves 338 that are shaped to allow for electrical wires to pass into the internal volume of the pod 313 even when the top portion is secured to the bottom portion. The electrical wires can be in electrical communication with the woofer 330 and the tweeter 334. In some examples, a printed circuit board or PCB (not shown in FIG. 3A) can be secured to a top of the woofer 330. The PCB can be secured, at least partially, by protrusions 342 that anchor the PCB in place above the woofer 330. The protrusions 342 can be helical coils. A heat sink can be positioned on top of or above the PCB. In some examples, the speaker assembly 312 can include a vent 346. The vent 346 can be a barometric vent that allows for air equalization within the speaker assembly 312.

FIG. 3B shows a cross-sectional side view of the speaker assembly 312 according to one embodiment. Similarly, FIG. 3C illustrates a perspective cross-sectional view of the speaker assembly 312 according to one embodiment. The woofer 330 can include a diaphragm 332 that oscillates along the vertical axis when an electrical current is provided to the woofer 330. Sound produced by the woofer diaphragm 332 can travel downward in a woofer volume 349 and can then be guided laterally or horizontally through the woofer channel 350. In some examples, at least a portion of the woofer volume 349 and the woofer channel 350 can be defined by an interior surface of a bottom wall of the pod 313.

In some examples, the sound produced by the woofer 330 can take a winding or tortuous path as it travels to the port 316. For example, the sound from the woofer 330 may need to change directions several times in order to reach the port 316. A long tortuous path can impact acoustic modes of that path, consequently impacting the output. As used herein, a tortuous path can refer to a winding or snaking path (e.g., non-linear). The tortuous path described herein can be a result of a horizontal interface 357 between the woofer 330 and tweeter 334 with the tweeter stacked or overlapping the woofer 330 as shown.

As illustrated in FIG. 3B, the pod 313 can include an overhang or lip 315. A perimeter or footprint of the lip 315 can be smaller than a perimeter or footprint of the combined audio components (e.g., woofer 330, tweeter 334, etc.) housed within the pod 313. Accordingly, the system may need to be assembled in a certain order and fashion due to the lip 315. For example, the dimensions of the pod 313 may prevent the woofer 330 and tweeter 334 from being simply attached or assembled before being placed into the pod 313. Instead, it may be necessary to first position the tweeter 334 or woofer 330 within the pod 313 and then place the remaining components into position. The components of the speaker assembly 312 may need to be angled or slid horizontally to be set into the correct position within the pod 313. The lip 315 can overlap or overhang a portion of the tweeter 334.

Further, as described herein, modern electronic devices often demand reduced dimensions that require novel solutions to fit the electronics within the housings or enclosures. For example, the electronic devices described herein can include integrated speaker assemblies that maintain a broad frequency range and desirable acoustic performance levels, despite residing in smaller, more compact housings. In some examples, this is achieved by overlapping or stacking the tweeter 334 and the woofer 330.

The overlapping tweeter 334 and woofer 330 configuration increases the compactness of the speaker assembly 312 and allows for assembly tolerances in the horizontal direction when assembling the speaker assembly 312. In addition, in at least one example, the overlapping configuration of the tweeter 334 and woofer 330 can result in the woofer channel 350 and/or tweeter channel 351 to change directions in a tortuous manner, for example from horizontal to vertical and/or other channel angles. The stacked nature of the speaker assembly 312 in combination with a single port 316 may result in a tortuous and winding path for the sound waves. For example, the horizontal interface 357 allows for horizontal assembly tolerances while causing the woofer channel 350 to direct upward in order to accommodate for the horizontal interface 357. In some examples, the tortuous path can be defined by smooth or curved walls to reduce or eliminate turbulence.

As shown in FIG. 3B, the horizontal interface 357 can include contacting or at least overlapping portions of the tweeter 334 and woofer 330, or the contacting or overlapping of certain walls or other components of the tweeter 334 and woofer 330, due to the stacked nature of the tweeter 334 and the woofer 330. Also, as used herein and as viewed in the orientation of FIG. 3B, the term “horizontal” can refer to a plane generally parallel to the planes in which the tweeter diaphragm 335 and the woofer diaphragm 332 are disposed. In one or more other examples, the stacked configuration/positioning of the tweeter 334 and woofer 330 can form an interface at an angle from the referenced “horizontal” orientation of the diaphragms 335, 332, such as any angle between horizontal and vertical (with “vertical” referencing an angle, plane, or orientation perpendicular to the diaphragms 335, 332 shown in FIG. 3B). Accordingly, in at least on example, the interface 357 included surfaces or components of the tweeter 334 and the woofer 330 coming together at an angle other than vertical, for example at a 45-degree angle from horizontal or any other angle from horizontal or vertical directions. As noted above, this angled or horizontal interface 357 can cause the path of sound generated by the woofer 330 and/or tweeter 334 to be tortuous or winding as shown in FIG. 3B.

A sloped or curved ramp 354 can be positioned and shaped to direct sound from the woofer volume 349 to the shared volume 352. For example, as the sound travels laterally, the curved ramp 354 guides the sound upward. The curved ramp 354 can include a smooth transition surface to reduce turbulence. The curved ramp 354 can include a radius of curvature of about 0.2 cm to 0.3 cm. It will be understood that the ramp 354 is optional and that in some examples, the sound produced by the woofer 330 travels in a primarily lateral or horizontal direction to the port 316.

In some examples, a mesh 358 (similar to the mesh 258) can be positioned at a terminus of the woofer channel 350. The mesh 358 can be positioned at an interface between the woofer 330 and the tweeter 334.

The speaker assembly 312 can include a wall 353. The wall 353 can be made from plastic and can be positioned below the tweeter 334 (e.g., between the tweeter 334 and the woofer channel 350). The wall 353 can be positioned to shield the tweeter 334 from the sound produced by the woofer 330. In some examples, the wall 353 can be curved to provide a smooth transition surface to direct upward directed sound laterally toward the port 316. In some examples, the wall 353 is positioned and/or shaped to direct sound from the tweeter 334 toward the port 316. The wall 353 can at least partially prevent sound from the tweeter 334 from passing into the woofer channel 350. The wall 353 can at least partially define the tweeter channel 351 and/or the woofer channel 350. In some examples, the wall 353 can extend substantially across the tweeter 334. The wall 353 can extend to the port mesh 360. Thus, the shared channel 352 can be omitted due to the wall 353 maintaining a separation of the woofer channel 350 and the tweeter channel 351.

The tweeter 334 can include a diaphragm 335. The diaphragm 335 can oscillate or vibrate along a vertical axis. The diaphragm 335 can oscillate in the same direction(s) as the diaphragm 332. The woofer diaphragm 332 can include a surface area that is approximately 10 times larger than that of the tweeter diaphragm 335.

In some examples, the tweeter 334 can be positioned closer to the port 316 than the woofer 330. The path taken by sound produced by the tweeter 334 can be substantially linear, or at least substantially less tortuous than the path taken by sound from the woofer 330. In some examples, sound generated by the tweeter 334 is initially directed in a downward direction but is guided substantially laterally, toward the port 316.

The speaker assembly 312 can include several interfaces (e.g., horizontal interface 357) between the woofer 330 and the tweeter 334 or between the speaker components and the pod 313. Foams can be positioned between the interfaces of the components and the speaker housing 313. Specifically, FIG. 3B shows a foam 363a positioned between a sidewall 364 of the pod 313 and the tweeter 334. Further, a foam 363b can be positioned between the interior surface of the pod 313 and a channel wall 366.

The foams 363a, 363b can include re-workable properties such as flexibility and malleability to allow free play within the speaker assembly 312. The foams 363a, 363b can be used in addition to or as a replacement for pressure sensitive adhesive (PSA). The foams 363a, 363b beneficially may not be permanently set, allowing for adjustment and repositioning of the components of the assembly. In some examples, the foams 363a, 363b can be used in conjunction with an adhesive. Advantageously, the foams between various interfaces of the components and the pod 313 can take up tolerances within the system. For example, a minimum sealing tolerance can be about 300 microns. The position of the foams 363a, 363b are merely example locations that foam can reside. It will be understood that foam can be located at various positions or interfaces not shown in FIGS. 3B and 3C.

In some examples, the port 316 is about 30 mm² across its cross sectional face. The size of the port 316 can depend on the capability of the woofer 330. The size of the port 316 can be driven by a desired particle velocity. For example, particle velocity can be a volume velocity (i.e., the volume of sound waves or air passing an area per unit time) divided by a cross sectional area of the port, where the volume velocity is dictated by the maximum output of the system at low frequencies. The particle velocity can be up to 50 meters per second. In some examples, the particle velocity is 10 meters per second. The port 316 can include a sleeve 319 positioned within the port 316 and extending around a perimeter of the port 316. The sleeve 319 can be made from plastic. The sleeve 319 can extend through the port opening 316 in the pod 313 and can also extend through the opening in the housing of the electronic device (e.g., opening 216a in FIG. 2).

FIG. 3D shows a top perspective view of a speaker module 317. The speaker module 317 can represent the certain electronics removed from the pod 313 described above. The speaker module 317 can include the woofer 330 and the tweeter 334. In some examples, the speaker module 317 can include a frame 347. The frame 347 can be secured to an interior surface of the pod 313. FIG. 3E shows a bottom perspective view of a speaker module 317. An underside surface of the frame 347 can be sealed to a bottom of the pod 313. In some examples, the speaker module 317 is sealed to the pod using an adhesive and/or foam, such as the foam 363 discussed above with regard to FIG. 3B. The woofer diaphragm 332, woofer channel 350, and mesh 358 are also visible from the underside of the speaker module 317 shown in FIG. 3E. In some examples, a barometric vent 346 can be positioned as illustrated between the mesh 358 and the woofer diaphragm 332.

FIG. 4 shows a perspective view of a port barrier 460. The port barrier 460 can be substantially similar to, including some or all of the features of, the meshes described herein, such as mesh 260 and 360. The port barrier 460 can be positioned within or across the opening of the electronic device, the port of the speaker assembly, and/or a shared channel (e.g., shared channel 252). The port barrier 460 can include an external screen 460a, a woven mesh 460b, and a frame 460c.

The external screen 460a can be a metallic structure that defines at least a portion of an exterior surface of the electronic device. In other words, the external screen 460a can be a cosmetic feature, visible to a user. In some examples, the external screen 460a can provide structural support to the woven mesh 460b. The external screen 460a can act as a particle or debris barrier to prevent particle ingress into the speaker assembly.

As discussed in greater detail above, with regard to FIG. 3B, the woven mesh 460b can include a cloth or fabric that is designed to allow for easy sound transmission through the material. The speaker port barrier 460 can include a predetermined sound transmissibility suitable for sound generated by the tweeter 234. The port barrier 460 can partially dampen the sound. In some examples, the woven mesh 460b can allow passage of frequencies from 20 Hz to 20 kHz. In some examples, the woven mesh 460b can allow passage of frequencies from 2 kHz to 20 kHz. The woven mesh 460b can be made from synthetic materials or threads in a woven pattern.

The port barrier 460 can be air-permeable. The port barrier 460 can occupy substantially an entire volume defined by at least one of the shared channel, the port (e.g., port 216b, 316), and the opening (e.g., opening 116, 216a). In some other examples, however, the port barrier 460 may only occupy a portion of at least one of the shared channel 252, the port 216b, and the opening 216a. In use, the port barrier 460 can serve to reduce the velocity of air flowing through the shared channel 252, thereby reducing undesirable flow noise and providing for a clearer acoustic signal to be heard by a user. In some examples, the port barrier 460 can block or prevent particle ingress through the shared channel 252. The port barrier 460 can have a lower density than the mesh 258.

The frame 460c can be positioned interior to the external screen 460a and woven mesh 460b. In some examples, the woven mesh 460b is positioned between or sandwiched between the external screen 460a and the frame 460c. The frame 460c can include a series of support ribs 461 to strengthen, shield, or provide support the woven mesh 460b. In some examples, the frame 460c is positioned external to the woven mesh 460b (i.e., between the external screen 460a and the woven mesh 460b. The frame 460c can be made from any suitable material, such as plastic or metal.

Personal information data, when gathered using authorized and well established secure privacy policies and practices, can be used with the various embodiments described herein. The disclosed technology remains operable without such personal information data.

It will be understood that the details of the present systems and methods above can be combined in various combinations and with alternative components. The scope of the present systems and methods will be further understood by the following claims.

What is claimed is:

1. A speaker assembly, comprising:
a housing defining an interior volume and a port, the port being in fluid communication with the interior volume and an outside environment;
a woofer positioned in the interior volume;
a tweeter positioned in the interior volume;
an outlet defined by the woofer, the outlet disposed at an interface between the woofer and the tweeter;
a first mesh covering the outlet; and
a second mesh covering the port, the first mesh being more dense than the second mesh.

2. The speaker assembly of claim 1, wherein a first distance between the port and the tweeter is smaller than a second distance between the port and the woofer.

3. The speaker assembly of claim 1, wherein:
the speaker assembly is housed in a personal electronic device; and
the port is directed toward an ear of a user during operation.

4. The speaker assembly of claim 1, further comprising a deformable foam positioned between the tweeter and the housing.

5. The speaker assembly of claim 1, further comprising a deformable foam positioned between a channel wall and the housing.

6. A speaker unit, comprising:
a housing defining an interior volume and an outlet, the outlet in fluid communication with the interior volume and an outside environment;
a woofer positioned in the interior volume, the woofer configured to transmit first acoustic waves having frequencies between 20 Hz and 2 kHz through a woofer channel in fluid communication with the outlet; and
a tweeter positioned in the interior volume, the tweeter configured to transmit second acoustic waves having frequencies between 200 Hz and 20 kHz through a tweeter channel in fluid communication with the outlet.

7. The speaker unit of claim 6, wherein the woofer channel comprises a tortuous path.

8. The speaker unit of claim 7, wherein the tortuous path extends through a non-vertical interface of the woofer and the tweeter.

9. The speaker unit of claim 8, wherein the tweeter at least partially overlaps the woofer, the overlap between the tweeter and the woofer defining the non-vertical interface.

10. The speaker unit of claim 8, wherein the woofer channel defines an outlet positioned at the non-vertical interface.

11. The speaker unit of claim 6, wherein the woofer is configured to generate the first acoustic waves in a first direction, and the woofer channel is configured to guide the first acoustic waves in a second direction perpendicular to the first direction.

12. The speaker unit of claim 6, further comprising a woofer mesh positioned between the woofer channel and the tweeter channel.

13. The speaker unit of claim 122, further comprising a tweeter mesh positioned at the outlet, wherein the woofer mesh comprises a woven fabric having a density higher than the tweeter mesh.

14. The speaker unit of claim 6, wherein the woofer channel is at least partially defined by an interior surface of the housing.

15. An electronic device, comprising:
a housing defining an opening;
a first speaker comprising a woofer in fluid communication with a first channel; and
a second speaker comprising a tweeter in fluid communication with a second channel;
wherein the first channel and the second channel converge into a shared channel in fluid communication with the opening.

16. The electronic device of claim 15, wherein the electronic device further comprises:
a first mesh positioned at the opening; and
a second mesh positioned at an interface between the woofer and the tweeter, the second mesh having a higher density than the first mesh.

17. The electronic device of claim 15, further comprising a barrier that covers the opening, the barrier comprising:
a woven mesh; and
a metallic screen defining an exterior of the electronic device.

18. The electronic device of claim 15, wherein:
the first speaker comprises a first diaphragm configured to oscillate along a first axis; and
the second speaker comprises a second diaphragm configured to oscillate along a second axis parallel to the first axis.

19. The electronic device of claim 15, further comprising a wall configured to shield the second speaker from acoustic waves generated by the first speaker, the wall at least partially defining the second channel.

20. The electronic device of claim 15. further comprising a speaker pod disposed within the housing, the speaker pod defining:
a port aligned with the opening;
the first channel; and
the second channel.
